(19) United States
(12) Patent Application Publication
(10) Pub. No.: US 2012/0288580 A1
(43) Pub. Date: Nov. 15, 2012

(54) Hot-Runner System Including Hot-Runner Component having Diamond-Based Material

(75) Inventor: Brian Esser, Colchester, VT (US)

(73) Assignee: HUSKY INJECTION MOLDING SYSTEMS LTD., Bolton, ON (CA)

(21) Appl. No.: 13/511,379

(22) PCT Filed: Oct. 20, 2010
(86) PCT No.: PCT/US2010/053281

§ 371 Date: May 23, 2012

Related U.S. Application Data
(60) Provisional application No. 61/265,809, filed on Dec. 2, 2009.

(51) Int. Cl. B29C 45/78; B29C 45/27; B23P 17/04

(52) U.S. Cl. 425/144; 29/428; 425/567

(57) ABSTRACT

A hot-runner system (100), including (but not limited to): a mold insert (132) defining a mold gate (134); and a diamond-based component connected with the mold insert (132), the diamond-based component connected surrounding the mold gate (134).

### TECHNICAL FIELD

An aspect of the present invention generally relates to (but is not limited to) a hot-runner system including (but not limited to) a hot-runner component having (but is not limited to) a diamond-based material. It is understood that the invention is described in the CLAIMS, and examples of the invention are described in the SUMMARY, DRAWINGS and DETAILED DESCRIPTION, and that only the CLAIMS define the scope of the invention.

### BACKGROUND OF THE INVENTION

publicly demonstrated it at the 1862 International Exhibition in London, calling the material Parkesine. Derived from cellulose, Parkesine could be heated, molded, and retain its shape when cooled. It was, however, expensive to produce, prone to cracking, and highly flammable. In 1868, American inventor John Wesley HYATT developed a plastic material he named Celluloid, improving on PARKES' invention so that it could be processed into finished form. HYATT patented the first injection molding machine in 1872. It worked like a large hypodermic needle, using a plunger to inject plastic through a heated cylinder into a mold. The industry expanded rapidly in the 1940s because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970s, HENDRY went on to develop the first gas-assisted injection molding process.

Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The total clamp force needed is determined by the projected area of the part being molded. This projected area is multiplied by a clamp force of from two to eight tons for each square inch of the projected areas. As a rule of thumb, four or five tons per square inch can be used for most products. If the plastic material is very stiff, it will require more injection pressure to fill the mold, thus more clamp tonnage to hold the mold closed. The required force can also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled.

Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems. Ceramics have been used as an insulating material for heaters used in hot-runner systems. Hot-runner systems are used in molding systems, along with mold assemblies, for the manufacture of plastic articles. Usually, hot-runners systems and mold assemblies are treated as tools that may be sold and supplied separately from molding systems.

U.S. Pat. No. 7,134,868 (Inventor: BABIN, et al.; Filed: 14 Nov. 2006 discloses an injection molding nozzle with a tip portion in the gate area of the mold that has a wear-resistant diamond-type coating. The surface of the tip melt channel that delivers melt to the gate area may also comprise a diamond-type coating. Nozzle seal surfaces in the gate area may also comprise a diamond-type coating.

U.S. Pat. No. 7,517,214 (Inventor: OLARU, et al.; Filed: 24 May 2007) discloses a thermally insulative component coupled to a forward surface of the bushing body in a hot runner. The thermally insulative component is made of a nonmetallic material having a thermal conductivity lower than that of the bushing body. The valve pin bushing includes a nonmetallic material that is a ceramic, and ceramics include, but are not limited to, alumina, zirconia, silicon carbide, silicon nitride, aluminum nitride, titanium carbide, titanium nitride, polycrystalline diamond, polycrystalline cubic boron nitride, boron carbide, and composite materials having ceramics (e.g., cermets).

United States Patent Publication Number 2009/0236774 (Inventor: JENKO, et al.; Published: Sep. 24, 2009) discloses a melt distribution apparatus that includes a plurality of chokes. The choke body may be a diamond body, a ceramic body, or a carbide body. Each choke may be constructed from a material that is compatible with the melt of molding material. The material may include, for example, wear resistant materials such as a ruby body, a diamond body, a ceramic body, or a carbide body.

United States Patent Publication Number 2005/0104242 (Inventor: OLARU; Filed: 12 Nov. 2004) discloses an injection molding system and injection molding method for making molded parts that include one or more planar heaters having a thin or a thick film resistive heater element coupled, secured, or releaseably secured to one or more sides of each of the one or more injection molding nozzles. A coating (e.g., a diamond or diamond-like (e.g., ceramic coating) can be placed over an outside surface of film heating elements or film heater device, which may be used to protect film heating elements and and/or the film heater device from damage. This can be done through a processing method, such as: (1) forming a dielectric layer (e.g., ceramic, diamond, or diamond-like layer) on a film heater support; (2) pattern the support with an electrical resistive layer; and (3) forming another dielectric layer (e.g., ceramic, diamond, or diamond-like layer). The heater device is at least partially coated with one of a diamond or ceramic coating.

### SUMMARY OF THE INVENTION

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of the instant patent application.

It is understood that “comprising” means “including but not limited to the following”.

According to one aspect, there is provided a method (800) of manufacturing a hot-runner system (100), the method (800) comprising: manufacturing (802) a hot-runner component (102); and affixing (804) a solid diamond-based material to the hot-runner component (102), wherein the solid diamond-based material exists in a solid state prior to being affixed to the hot-runner component (102).

According to another aspect, there is provided a hot-runner system (100), comprising: a mold insert (132) defining a mold gate (134); and a diamond-based component connected with the mold insert (132), the diamond-based component connected surrounding the mold gate (134).

According to yet another aspect, there is provided a hot-runner system (100), comprising: a first hot-runner component (500); a second hot-runner component (502) being movable relative to the first hot-runner component (500); a diamond-based component being located between the first hot-runner component (500) and the second hot-runner component (502), the diamond-based component reducing wear and friction between the first hot-runner component (500) and the second hot-runner component (502).

According to yet again another aspect, there is provided a hot-runner system (100), comprising: a manifold assembly (999); a manifold thermal-management device (998) being coupled to the manifold assembly (999); and a diamond-based component (997) being positioned between the manifold assembly (999) and the manifold thermal-management device (998).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

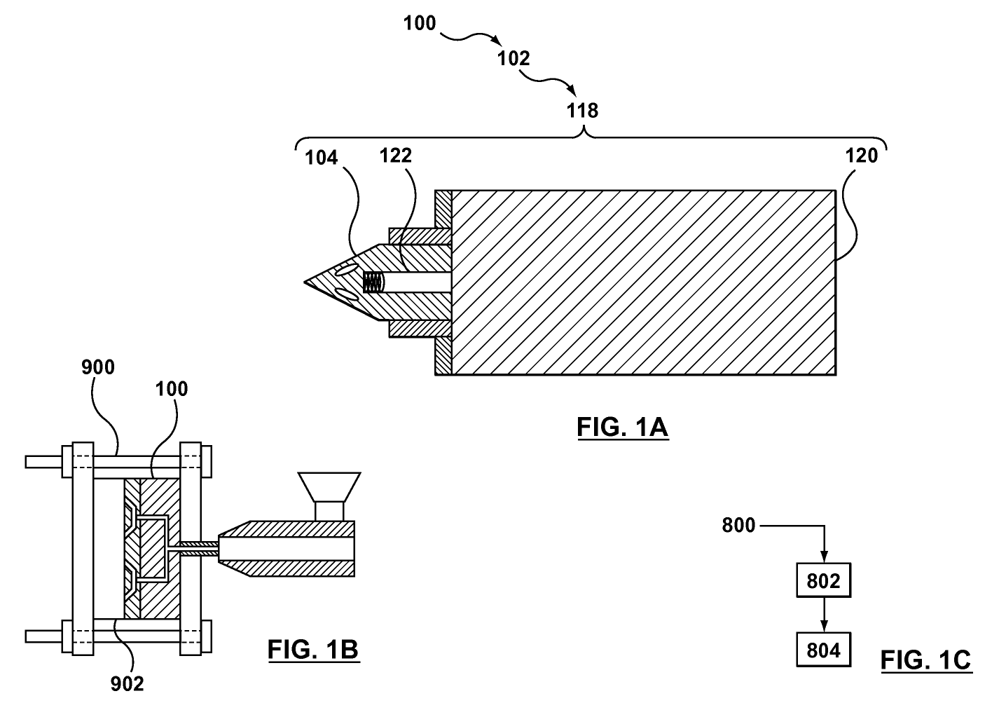

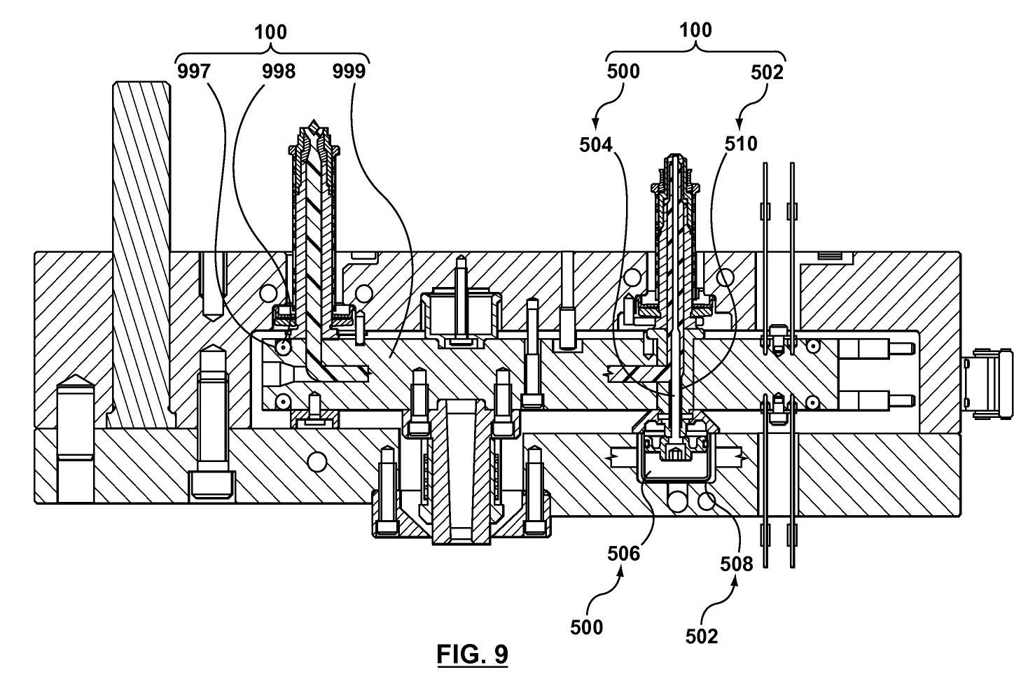

FIGS. 1A, 1B, 10, 2, 3A, 3B, 4, 5, 6, 7, 8, 9 depict schematic representations of a hot-runner system (100) including a hot-runner component (102) having a diamond-based material.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

The hot-runner system (100) may include components, which may or may not be depicted, that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9).

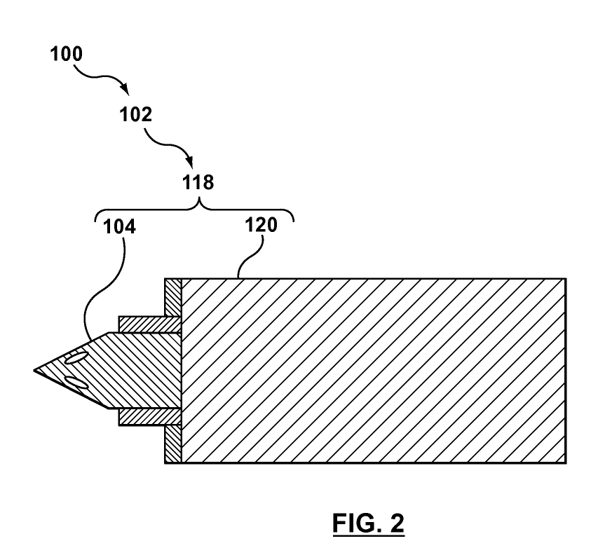

FIG. 1A depicts a schematic representation of the hot-runner system (100) including the hot-runner component (102). The hot-runner system (100) includes (but is not limited to): the hot-runner component (102) having (but not limited to) a diamond-based material. FIG. 1A depicts an example of the hot-runner component (102), in which the hot-runner component (102) includes (but is not limited to) a nozzle assembly (118). The nozzle assembly (118) includes (but is not limited to): (i) a nozzle body (120), (ii) the nozzle tip (104) connected to an end of the nozzle body (120), and (iii) a heating element (122) embedded in (or connected with) the nozzle tip (104). The nozzle tip (104) depicted in FIG. 2B includes the diamond-based material. It will be appreciated that the heating element (122) is optional.

The diamond-based material may include a diamond and/or any material that may be harder than diamond. Examples of a material that is harder than diamond are: (i) wurtzite boron nitride (w-BN), and/or (ii) lonsdaleite (also called hexagonal diamond since it's made of carbon and is similar to diamond) that is even stronger than w-BN and approximately 58 percent stronger than diamond. The diamond-based material is a material that may include, for example, diamond, diamond-like materials, which may be natural diamonds, synthetic (man-made) diamonds, diamond-filled composites, and/or other similar materials that have properties similar to that of diamond such as diamond-like carbon films (for example). Diamond is an allotrope of carbon, where the carbon atoms are arranged in a variation of the face centered cubic crystal structure called a diamond lattice. The diamond-based material may include, for example: a composite of diamond and a copper alloy. The diamond-based material may include for example: bulk diamonds, diamond filled metals, diamond filled composites, diamond-ceramic composites, and diamond and diamond based films, as well as diamond like materials (diamond like carbon, cubic boron nitride, silicon carbide, etc). An example of a supplier of the diamond-based material is PLANSEE SE (Austria; Telephone +43 (5672) 600-0). PLANSEE offers diamond-based materials based on silver, aluminum, and copper matrices. Diamond composites are an acceptable material for thermal management. A technical effect associated with using the diamond-based material is (amongst other things): (i) improved cooling due to the high thermal conductivity of the diamond-based material), and/or (ii) improved wear resistance. The diamond-based material has a technical advantage, amongst others, of being (relatively) electrically insulative, (relatively) thermally conductive, and (relatively) mechanically robust (i.e., a high wear resistance). An electrically insulative material is an insulator (also called a dielectric), which is a material that resists the flow of electric current. An insulating material has atoms with tightly bonded valence electrons. These materials are used in parts of electrical equipment, also called insulators or insulation, intended to support or separate electrical conductors without passing current through themselves. The term is also used more specifically to refer to insulating supports that attach electric power transmission wires to utility poles or pylons. A thermally conductive material is the property of a material that indicates its positive ability to conduct heat (as opposed to retard the flow of heat). A material that is mechanically robust has the ability to resist the gradual wearing away caused by abrasion and friction. As a result of these combinations of properties, the diamond-based material is suited for use in the hot-runner component (102) of the hot-runner system (100), amongst other things.

Examples of the hot-runner component (102) are (but not limited to): a nozzle tip (104), a nozzle-tip insert, a nozzle seal-off surface, a piston surface, an insulation coupling, a thermal coupling, a mold-gate insert (sometimes called a “gate insert”), a mold assembly, a sprue-bar shutoff, an ejector pin (used to eject the molded article from the mold assembly), etc. For the valve gate guidance surface, the diamond material may be placed on a stem surface, a guidance surface or both. For the nozzle tip seal surface or the gate seal surface, the diamond-based material may be placed on a nozzle-tip seal surface, a gate-seal surface or both. In view of the above description, it will be appreciated that a method of manufacturing the hot-runner system (100) includes (but is not limited to): applying the diamond-based material to the hot-runner component (102).

FIG. 1B depicts a schematic representation of a molding system (900) and a mold assembly (902), in which the hot-runner system (100) may be used or installed in the following combination: (i) the molding system (900), and/or (ii) the molding system (900) having the mold assembly (902) that is connectable with the hot-runner system (100). Additionally, it is also contemplated providing the mold assembly (902) including (but not limited to): the diamond-based material.

FIG. 1C depicts a schematic representation of a method (800). The method (800) is used for manufacturing the hot-runner system (100). The method (800) includes (but is not limited to): (i) manufacturing (802) a hot-runner component (102), and (ii) affixing (804) a solid diamond-based material to the hot-runner component (102). The solid diamond-based material exists in a solid state prior to being affixed to the hot-runner component (102). It will be appreciated that the term “affixed” does not include diamond in a gaseous state or a diamond in a plasma state. The term “affixed” includes affixing solids to solids and may also include temporarily affixing liquid to solid but the liquid becomes solidified. The hot-runner component (102) and the solid diamond-based component are manufactured and constructed and formed individually into solid forms, and then the solid forms are affixed to each other. The solid diamond-based component does not include a coating made from depositing a gaseous material that forms a diamond-based material deposited to the hot-runner component (102). The step of affixing does not include affixing plasmas or gases to solids. Affixing may include liquids affixed to solids, and includes affixing solids to solids.

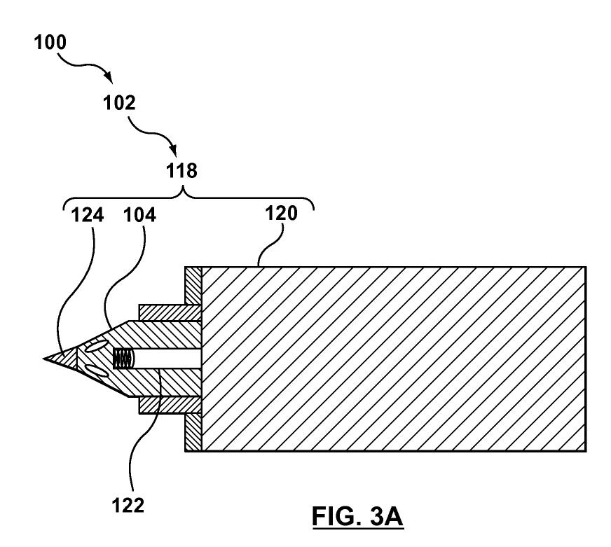

FIG. 2 depicts another example of the hot-runner component (102), in which the hot-runner component (102) includes (but is not limited to) the nozzle assembly (118). The nozzle assembly (118) includes (but is not limited to): (i) the nozzle body (120), and (ii) the nozzle tip (104) connected to the end of the nozzle body (120). A heating element is not embedded in or connected with the nozzle tip (104). The nozzle tip (104) depicted in FIG. 3A includes the diamond-based material. It will be appreciated that the diamond-based material may be installed or used in other components of the hot-runner system (100).

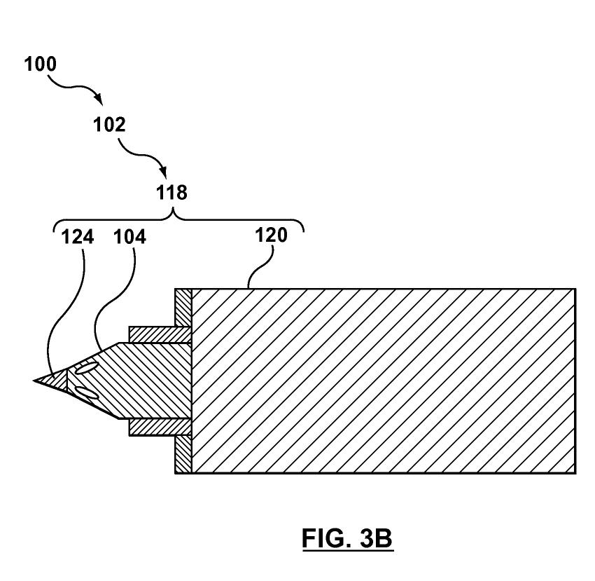

FIG. 3A depicts yet another example of the hot-runner component (102), in which the hot-runner component (102) includes (but is not limited to) the nozzle assembly (118). The nozzle assembly (118) includes (but is not limited to): (i) the nozzle body (120), (ii) the nozzle tip (104) connected to the end of the nozzle body (120), (iii) the heating element (122) embedded in (or connected with) the nozzle tip (104), and (iv) a nozzle tip insert (124) connected with an end of the nozzle tip (104) opposite to where the nozzle body (120) connects with the nozzle tip (104). The nozzle tip insert (124) includes the diamond-based material. The nozzle tip (104) depicted in FIG. 4 may or may not include the diamond-based material.

FIG. 3B depicts yet another example of the hot-runner component (102), in which the hot-runner component (102) includes (but is not limited to) the nozzle assembly (118). FIG. 4 depicts the outer view (as opposed to the cross section) of the nozzle assembly (118). It will be appreciated that the nozzle assembly (118) defines a melt passageway that is not depicted in FIG. 4. The nozzle assembly (118) includes (but is not limited to): (i) the nozzle body (120), (ii) the nozzle tip (104) that is connected to the end of the nozzle body (120), (iii) the nozzle tip insert (124) connected with an end of the nozzle tip (104). There is no heating element embedded in (or connected with) the nozzle tip (104). The nozzle tip insert (124) includes the diamond-based material. The nozzle tip (104) depicted in FIG. 4 may or may not include the diamond-based material.

FIG. 4 depicts yet another example of the hot-runner component (102), in which the hot-runner component (102) includes (but is not limited to) the nozzle assembly (118). The nozzle assembly (118) includes (but is not limited to): (i) the nozzle body (120) defining a melt passageway (121), (ii) the nozzle tip (104) attached to an end of the nozzle body (120), and (iii) a mold insert (132) defining a mold gate (134). The mold insert (132) receives the nozzle tip (104) so that the nozzle tip (104) may fluidly communicate with the mold gate (134). The mold gate (134) is lined with or coated with the diamond-based component (135). The mold gate (134) is sometimes called a “mold gate”. The hot-runner system (100) includes (but is not limited to): (i) the mold insert (132) defining the mold gate (134), and (ii) the diamond-based component connected with the mold insert (132), the diamond-based component connected surrounding the mold gate (134).

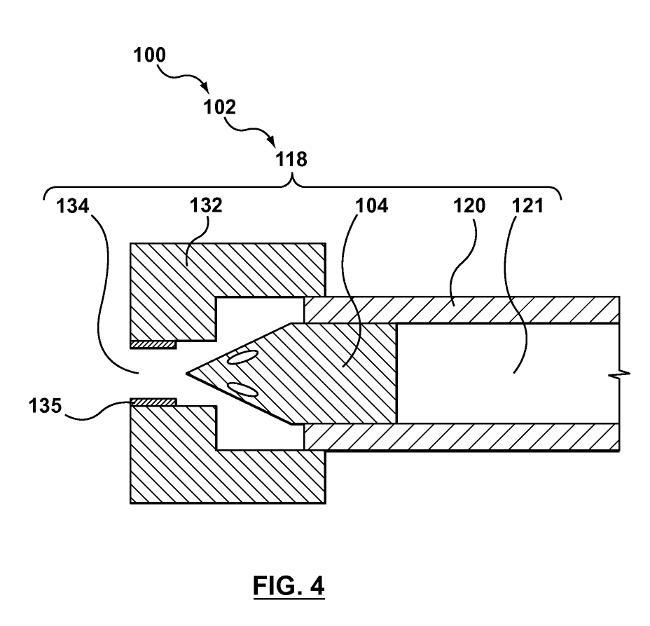

FIG. 5 depicts yet another example of the hot-runner component (102), in which the hot-runner component (102) includes (but is not limited to) the nozzle assembly (118). The nozzle assembly (118) includes (but is not limited to): (i) the nozzle body (120) defining the melt passageway (121), (ii) the nozzle tip (104) attached to an end of the nozzle body (120), (iii) the mold insert (132) defining the mold gate (134), (iv) the inner insulator (128), (v) the outer insulator (129), and (vi) the heating element (122). The wire (133) is used for supplying electricity to the heating element (122). The mold insert (132) receives the nozzle tip (104) so that the nozzle tip (104) may fluidly communicate with the mold gate (134). The inner insulator (128) is attached to the inner wall of the mold gate (134), and the heating element (122) is attached to the inner insulator (128). The outer insulator (129) is attached to the heating element (122). The inner insulator (128) has the diamond-based material, and the outer insulator (129) has the diamond-based material and a moisture barrier. According to one option, the inner insulator (128) does not have the diamond-based material, and the outer insulator (129) has the diamond-based material and a moisture barrier. According to another option, the inner insulator (128) has the diamond-based material, and the outer insulator (129) has no diamond-based material and has a moisture barrier. The outer insulator (129) defines, at least in part, the mold gate (134). According to one variation or option, a thermal management device (119) is coupled to the diamond-based component, and the thermal management device (119) is configured to actively manage thermal energy associated with the mold insert (132). Specifically, the thermal management device (119) has a heating element (122) coupled to the diamond-based component, and the thermal management device (119) is configured to actively manage thermal energy associated with the mold insert (132).

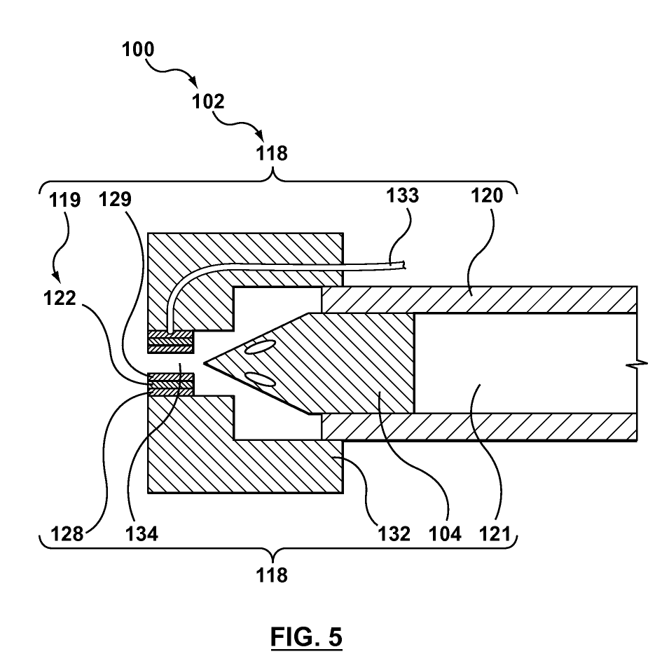

FIG. 6 depicts yet another example of the hot-runner component (102), in which the hot-runner component (102) includes (but is not limited to) the nozzle assembly (118). The nozzle assembly (118) includes (but is not limited to): (i) the nozzle body (120) defining the melt passageway (121), (ii) the nozzle tip (104) attached to an end of the nozzle body (120), (iii) the mold insert (132) defining the mold gate (134), and (iv) a cooling element (136) that defines the mold gate (134) at least in part. The cooling element (136) is received by the mold insert (132). The mold insert (132) receives the nozzle tip (104) so that the nozzle tip (104) may fluidly communicate with the mold gate (134). The cooling element (136) defines, at least in part, the mold gate (134). The cooling element (136) that defines the mold gate (134) is lined, at least in part, with the diamond-based component (135). The cooling element (136) includes (by way of example, but not limited to) a cooling conduit (137) for receiving and conveying a cooling fluid. The cooling element (136) includes the diamond-based material in the body of the cooling element (136), and the cooling element (136) is lined with the diamond-based component (135). According to an option, the thermal management device (119) has a cooling element (136) coupled to the diamond-based component, and the thermal management device (119) is configured to actively manage thermal energy associated with the mold insert (132).

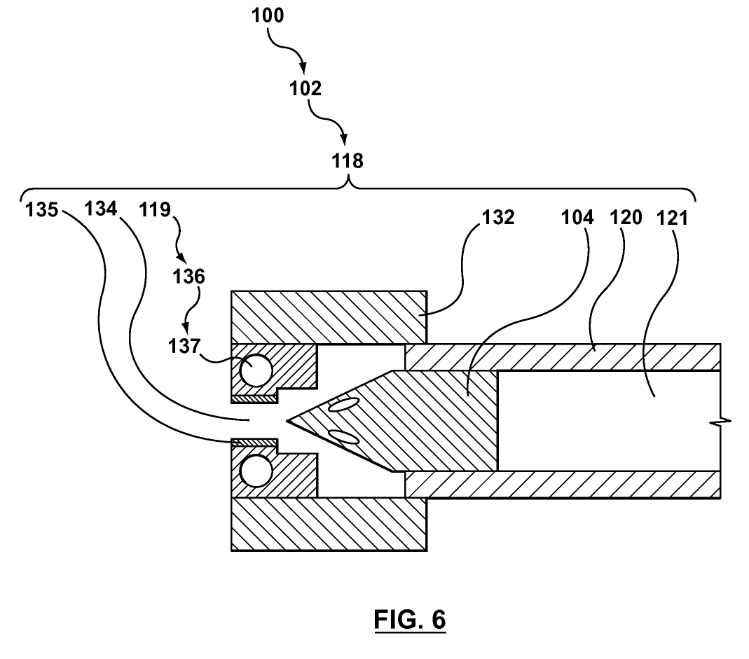

FIG. 7 depicts yet another example of the hot-runner component (102), in which the hot-runner component (102) includes (but is not limited to) the nozzle assembly (118). The nozzle assembly (118) includes (but is not limited to): (i) the nozzle body (120) defining the melt passageway (121), (ii) the nozzle tip (104) attached to an end of the nozzle body (120), (iii) the mold insert (132) defining the mold gate (134), (iv) the cooling element (136), such as a cooling circuit having a coolant, etc, that defines, at least in part, the mold gate (134), and (v) the heating element (122). The mold insert (132) receives the nozzle tip (104) so that the nozzle tip (104) may fluidly communicate with the mold gate (134). The cooling element (136) is received by the mold insert (132), and the cooling element (136) includes the cooling conduit (137) for receiving and conveying the cooling fluid. The heating element (122) is connected with the cooling element (136), and the diamond-based component (135) is coated or attached to the heating element (122). This is an example of a heating element located between a gate surface and a cooling mechanism, which is cycled during the molding cycle of the molding system (900). According to an option, the thermal management device (119) has the heating element (122) and a cooling element (136) coupled to the diamond-based component, and the thermal management device (119) is configured to actively manage thermal energy associated with the mold insert (132).

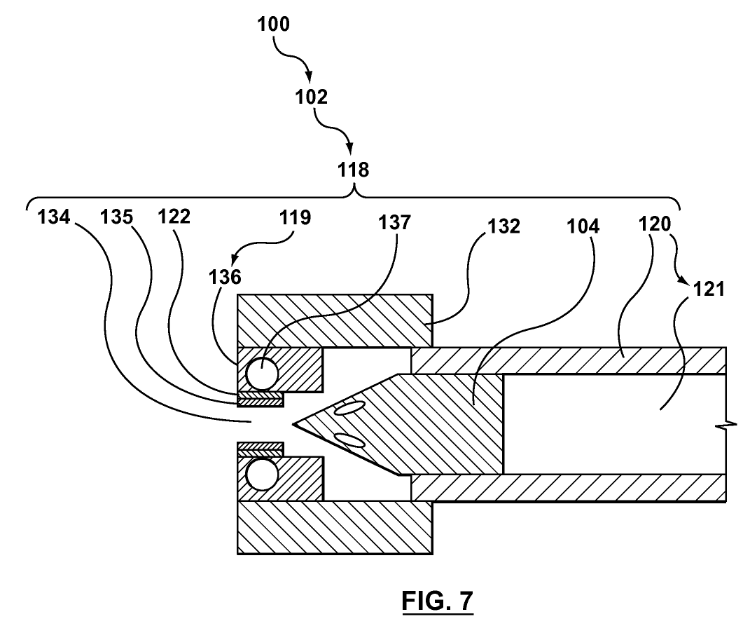

FIG. 8 depicts yet another example of the hot-runner component (102), in which the hot-runner component (102) includes (but is not limited to) the nozzle assembly (118). The nozzle assembly (118) includes (but is not limited to): (i) the nozzle body (120) defining the melt passageway (121), (ii) the nozzle tip (104) attached to an end of the nozzle body (120), (iii) the mold insert (132) defining the mold gate (134), and (iv) the cooling element (136) that defines the mold gate (134) at least in part. The mold insert (132) receives the nozzle tip (104) so that the nozzle tip (104) may fluidly communicate with the mold gate (134). The cooling element (136) is received by the mold insert (132), and the cooling element (136) includes the cooling conduit (137) for receiving and conveying the cooling fluid. The cooling element (136) includes the diamond-based material.

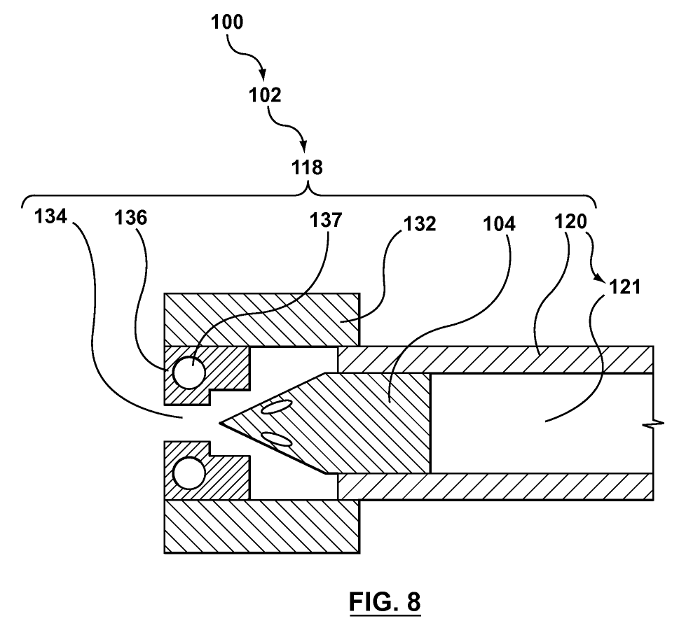

FIG. 9 depicts a schematic representation of the hot-runner system (100). The hot-runner system (100) includes: (i) a first hot-runner component (500), and (ii) a second hot-runner component (502) that is movable relative to the first hot-runner component (500). The diamond-based component is located between the first hot-runner component (500) and the second hot-runner component (502). The diamond-based component reduces wear and friction between the first hot-runner component (500) and the second hot-runner component (502). For example, the first hot-runner component (500) includes a valve stem (504), and the second hot-runner component (502) includes a surface defining a channel (510) for receiving the valve stem (504). According to another example, the first hot-runner component (500) includes a piston surface (506), and the second hot-runner component (502) includes a cylinder surface (508) defining a channel for receiving the piston surface (506).

### General Discussion

Since diamond and diamond like materials are extremely hard and wear resistant, it may be possible to insert the diamond-based material directly into the melt. It will be appreciated that it is not intended to use the diamond based material as a molding material. Whereas typical insulator materials (such as ceramic) are relatively weaker and brittle, requiring them to be mechanically supported, the diamond-based material is relatively more mechanically robust and thus would not likely require additional mechanical support. This would lend the use of the diamond-based material as insulated heated components.

Diamond has a very interesting combination of extreme properties, such as high hardness (wear resistance), excellent dielectric strength (good electrical insulator), and tremendously high thermal conductivity. In sharp contrast, known hot-runner insulator materials are relatively weak and brittle, requiring them to be mechanically supported, diamond and diamond-like materials are mechanically robust and thus would not likely require additional mechanical support, thus making it possible to insert diamond and diamond based materials directly, at least in part, into the hot melt. This would lend the use of diamond and diamond-like insulated heating technologies to the following applications in the molding system (900), and more specifically in the hot-runner system (100), and the examples are (but are not limited to) examples A-F described below:

Example A: nozzle tips with integrated diamond insulated heaters (actually inside the tip), where the diamond insulator is in contact with the molten plastic. Diamond-based nozzle tip with or without integrated heating element, which may be a diamond based composite (diamond or diamond like material combined with other materials). Diamond composites can be formulated to have specific coefficients of thermal expansion. Excellent thermal conductivity, wear resistance, etc.

Example B: gate inserts where the actual gate is heated and the gate surface contacting the melt is a diamond based insulative material (this may be coupled with a diamond based gate pressure drop orifice). Diamond coated gate (with or without embedded heater). High thermal conductivity results in excellent cooling. Heater can be used to open gates, or to tune part weights to improve balance. High wear resistance—good for abrasive resins.

Example C: diamond based substrate for nozzle or manifold heating elements. Some technologies are currently being employed to create a resistive (heating) layer with numerous means of deposition techniques, such as: chemical vapor deposition (CVD), plasma spray or equivalent. Using deposited diamond and diamond like coatings as the substrate for theses heating elements has the advantage that the layer is strong, highly electrically insulative, and highly thermally conductive. Diamond can be deposited using similar methods, including plasma spray, CVD, sintering, brazing, cathodic arc evaporation, dielectric barrier discharge, etc. Another example is diamond insulated nozzle heater. Slip on or direct application.

Example D: diamond based substrate for typical nichrome (wire or ribbon) based heating elements. Traditional nichrome based wire heating elements can benefit from the electrically insulative and thermally conductive properties of diamond and diamond based coatings. This could be for both nozzle and manifold heating applications, among others (tips, gate inserts, etc.)

Example E: since diamond has good thermal and mechanical properties, it may be used in tip materials even in the absence of an embedded heating element. A diamond hot tip insert would have the benefits of excellent mechanical strength, wear characteristics, and thermal conductivity.

Example F: diamond based coatings may have applications in melt channel coatings to protect the underlying material from wear. Applications include gates and gate inserts, nozzle melt channels, manifolds, sprue bar shutoffs, etc.

Other examples are: (i) wear resistant wetted surfaces (gates, tips, melt channels, etc.), including precision gate orifices, (ii) wear resistant, low friction sealing surfaces (piston seals, cylinder linings, stem guidance, sprue bar shutoffs, tip/gate seal-off, ejector pins, etc), (iii) coatings or components for areas which have alternating heat/cool cycles. Gate inserts where the actual gate orifice is heated and the gate surface contacting the melt is a diamond based material. Heated molds for extreme thin wall applications (diamond film produces a very smooth, wear resistant surface while providing electrical isolation and thermal transparency), (iv) nozzle tips with integrated diamond insulated heaters (actually inside the tip), where the diamond insulator is in contact with the molten plastic, (v) diamond based substrate for deposited nozzle or manifold heating elements, (vi) diamond based substrate for typical nichrome (wire or ribbon) based heating elements. This could be used for both nozzle and manifold heating applications, among others (tips, gate inserts, etc.)

According to an option, the hot-runner system (100), includes (but is not limited to): (i) a manifold assembly (999), (ii) a manifold thermal-management device (998) that is coupled to the manifold assembly (999), and a diamond-based component (997) that is positioned between the manifold assembly (999) and the manifold thermal-management device (998). The manifold thermal-management device (998) may include, for example, a manifold-heating element (also known as a heater, etc) and/or a manifold-cooling element (also known as a cooling conduit, etc).

It is noted that the foregoing has outlined some of the more pertinent non-limiting embodiments. Thus, although the description is made for particular arrangements and methods, the intent and concept of the aspects is suitable and applicable to other arrangements and applications. It will be clear to those skilled in the art that modifications to the disclosed embodiments can be effected without departing from the scope the independent claims. It is understood that the described embodiments are merely illustrative of the independent claims.

What is claimed is:

1. A method (800) of manufacturing a hot-runner system (100), the method (800) comprising:
manufacturing (802) a hot-runner component (102); and
affixing (804) a solid diamond-based material to the hot-runner component (102),
wherein the solid diamond-based material exists in a solid state prior to being affixed to the hot-runner component (102).

2. A hot-runner system (100), comprising:
a mold insert (132) defining a mold gate (134); and
a diamond-based component connected with the mold insert (132), the diamond-based component connected surrounding the mold gate (134).

3. The hot-runner system (100) of claim 2, further comprising:
a thermal management device (119) coupled to the diamond-based component, the thermal management device (119) being configured to actively manage thermal energy associated with the mold insert (132).

4. The hot-runner system (100) of claim 2, further comprising:
a thermal management device (119) having a heating element (122) being coupled to the diamond-based component, the thermal management device (119) being configured to actively manage thermal energy associated with the mold insert (132).

5. The hot-runner system (100) of claim 2, further comprising:
a thermal management device (119) having a cooling element (136) being coupled to the diamond-based component, the thermal management device (119) being configured to actively manage thermal energy associated with the mold insert (132).

6. The hot-runner system (100) of claim 2, further comprising:
a thermal management device (119) having a heating element (122) and a cooling element (136) being coupled to the diamond-based component, the thermal management device (119) being configured to actively manage thermal energy associated with the mold insert (132).

7. A hot-runner system (100), comprising:
a first hot-runner component (500);
a second hot-runner component (502) being movable relative to the first hot-runner component (500); and
a diamond-based component being located between the first hot-runner component (500) and the second hot-runner component (502), the diamond-based component reducing wear and friction between the first hot-runner component (500) and the second hot-runner component (502).

8. The hot-runner system (100) of claim 7, wherein:
the first hot-runner component (500) includes a valve stem (504); and
the second hot-runner component (502) includes a surface defining a channel for receiving the valve stem (504).

9. The hot-runner system (100) of claim 7, wherein:
the first hot-runner component (500) includes a piston surface (506); and
the second hot-runner component (502) includes a surface defining a cylinder surface (508) for receiving the piston surface (506).

10. A hot-runner system (100), comprising:
a manifold assembly (999);
a manifold thermal-management device (998) being coupled to the manifold assembly (999); and
a diamond-based component (997) being positioned between the manifold assembly (999) and the manifold thermal-management device (998).
